(19) United States
(12) Patent Application Publication
(10) Pub. No.: US 2015/0002367 A1
(43) Pub. Date: Jan. 1, 2015

(54) ANTENNA DEVICE AND WIRELESS TERMINAL DEVICE USING THE SAME

(71) Applicant: NEC CORPORATION, Tokyo (JP)

(72) Inventors: Keishi Kosaka, Tokyo (JP); Hiroshi Toyao, Tokyo (JP); Yoshiaki Kasahara, Tokyo (JP)

(73) Assignee: NEC CORPORATION, Minato-ku, Tokyo (JP)

(21) Appl. No.: 14/375,179

(22) PCT Filed: Mar. 15, 2013
(86) PCT No.: PCT/JP2013/001767

§ 371 Date: Jul. 29, 2014

(30) Foreign Application Priority Data
Mar. 22, 2012 (JP) 2012-064789

(51) Int. Cl. H01Q 1/52

(52) U.S. Cl. CPC H01Q 1/523
USPC 343/893

(57) ABSTRACT

There are provided an antenna device that comprises: a conductor plate; at least two antenna elements arranged near an end of the conductor plate; a first slotline formed into the conductor plate, the first slotline having a characteristic impedance of an optional numerical value Z1; a second slotline formed into the conductor plate, the second slotline having a characteristic impedance of an optional numerical value Z2 larger than Z1; one end of the first slotline being an open end in an area between the antenna elements within the conductor plate end; the other end of the first slotline connecting with one end of the second slotline; and the other end of the second slotline being short-circuited inside the conductor plate, and wireless terminal apparatus using this.

### TECHNICAL FIELD

The present invention relates to an antenna device having a plurality of antenna elements and, more particularly, to an antenna device which reduces interference between the antenna elements and achieves space-saving and miniaturization.

### BACKGROUND ART

As an antenna device, there is known a diversity antenna which improves the transmission rate of a signal by receiving identical wireless signals separately by a plurality of antenna elements, and using a received signal from an antenna element superior in a radio wave state on a priority basis. Also, recently, as an antenna device, a MIMO (Multi-Input Multi-Output) antenna which improves the transmission rate of a signal dramatically by transmitting or receiving a plurality of different wireless signals within an identical bandwidth simultaneously using a plurality of antenna elements and by increasing the number of channels of a signal as much as the number of the antenna elements is being paid attention.

When performing wireless communication using a diversity antenna or a MIMO antenna mentioned above, it is said that it is desirable that a plurality of antenna elements are in a low correlation state with each other as much as possible. However, when a plurality of antenna elements are mounted onto a radio apparatus, a radio terminal or the like, a distance between the antenna elements often cannot be separated sufficiently relative to the wavelength of a received radio wave due to restrictions in the size of the apparatus or the terminal and in a space which can be used for the antenna elements. Therefore, there is a problem that a low correlation cannot be realized in such occasions due to electromagnetic interference between a plurality of antenna elements (inter-antenna element interference), and the communication performance of a diversity antenna and a MIMO antenna degrades.

Accordingly, there is known an electronic apparatus equipped with an antenna device which makes interference between antenna elements be reduced by forming a slotline of a length corresponding to ¼ wavelength of the resonance frequency of the antenna elements into a portion corresponding to an area between the plurality of antenna elements among end parts of a ground pattern connected to the plurality of antenna elements through feeding points (patent document 1), for example.

### CITATION LIST

### Patent Literature

[Patent Literature 1] Japanese Patent Application Laid-Open No. 2008-283464

### SUMMARY OF INVENTION

### Technical Problem

However, in an antenna described in patent literature 1, there is caused a problem that, when a slotline is provided in an end part of a ground pattern, an installation space for various devices installed on the ground pattern becomes small due to a space corresponding to the length of the slotline because the slotline of the length of ¼ wavelength corresponding to the resonance frequency of the antenna elements is needed to be formed.

The present invention has been made in view of the above-mentioned problem, and its object is to provide an antenna device which can achieve space-saving or miniaturization while keeping given characteristics as an antenna element by reducing interference between antenna elements and wireless terminal apparatus using this.

### Solution to Problem

One aspect of the present invention for achieving the above-mentioned object is an antenna device that comprises: a conductor plate; at least two antenna elements arranged near an end of the conductor plate; a first slotline formed into the conductor plate, the first slotline having a characteristic impedance of an optional numerical value Z1; a second slotline formed into the conductor plate, the second slotline having a characteristic impedance of an optional numerical value Z2 larger than Z1; one end of the first slotline being an open end in an area between the antenna elements within the conductor plate end; the other end of the first slotline connecting with one end of the second slotline; and the other end of the second slotline being short-circuited inside the conductor plate, and wireless terminal apparatus using this.

### Advantageous Effect of Invention

An antenna device which can achieve space-saving or miniaturization while keeping given characteristics as an antenna element by reducing interference between antenna elements and wireless terminal apparatus using this can be provided because interference between the antenna elements can be reduced in a state that the total line length of a first slotline and a second slotline is shorter than a case when a slotline of a line length of ¼ length of the wavelength corresponding to the resonance frequency of the antenna elements is formed.

### BRIEF DESCRIPTION OF DRAWINGS

FIG. 1 is a side view showing a structure of an antenna device of a first exemplary embodiment of the present invention.

FIG. 2 is a top view showing a structure of an antenna device of the first exemplary embodiment of the present invention.

FIG. 3 is a perspective view showing a structure of wireless terminal apparatus equipped with an antenna device of the first exemplary embodiment of the present invention.

FIG. 4 is a diagram showing a result of simulation about S₂₁ parameter of an antenna device of the first exemplary embodiment of the present invention.

FIG. 5 is a top view showing a structure of an antenna device of the first exemplary embodiment of the present invention.

FIG. 6 is a top view showing a structure of an antenna device of a second exemplary embodiment of the present invention.

FIG. 7 is a perspective view showing a structure of a conductor part of an antenna device of the second exemplary embodiment of the present invention.

FIG. 8 is a perspective view showing a structure of a conductor part of an antenna device of the second exemplary embodiment of the present invention.

FIG. 9 is a side view showing a structure of a conductor part of an antenna device of the second exemplary embodiment of the present invention.

FIG. 10 is a side view showing a structure of an antenna device of a third exemplary embodiment of the present invention.

FIG. 11 is a top view showing a structure of an antenna device of the third exemplary embodiment of the present invention.

FIG. 12 is a top view showing a structure of an antenna device of a fourth exemplary embodiment of the present invention.

FIG. 13 is a top view showing a structure of an antenna device of a fifth exemplary embodiment of the present invention.

### DESCRIPTION OF EMBODIMENTS

Hereinafter, an exemplary embodiment of the present invention will be described in detail with reference to a drawing. However, although technically preferred limitation to carry out the present invention is made to the exemplary embodiments described below, it does not limit the scope of the invention as below.

### First Exemplary Embodiment

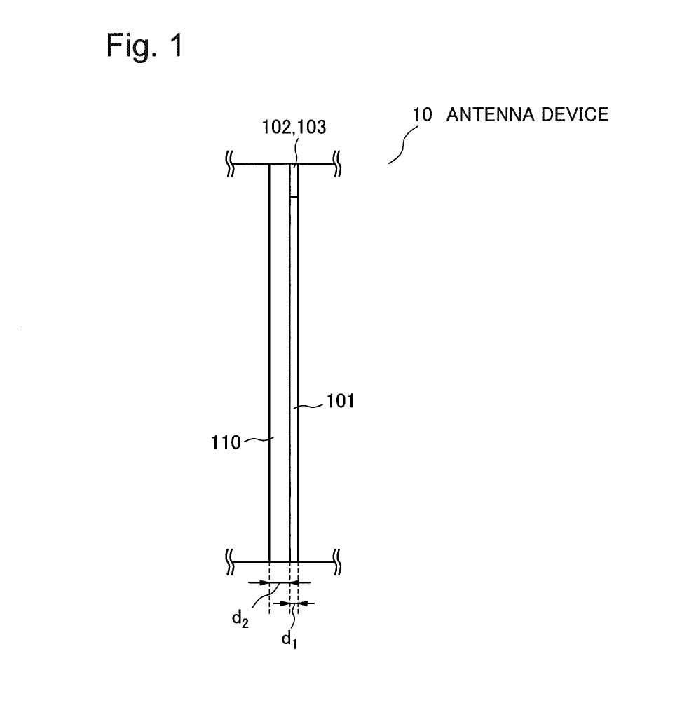

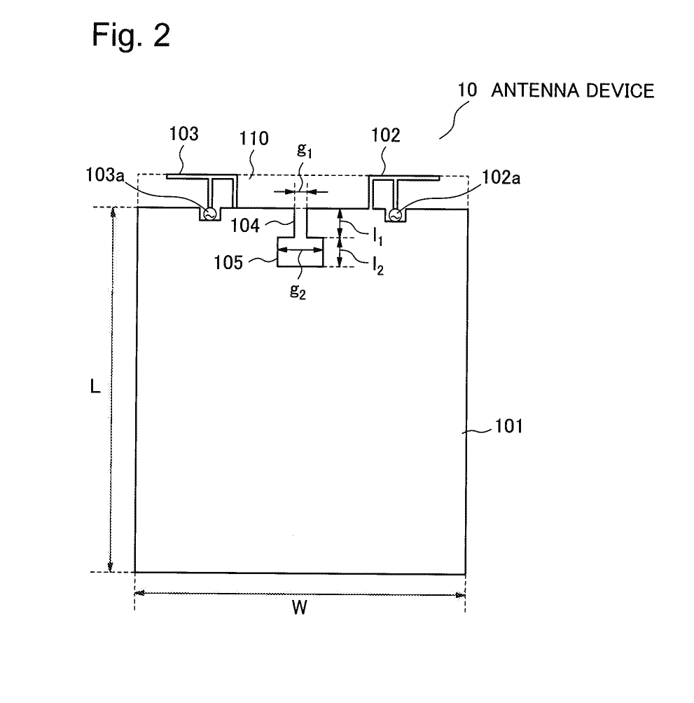

FIG. 1 is a side view showing a structure of an antenna device of the first exemplary embodiment of the present invention. FIG. 2 is a top view showing a structure of an antenna device of the first exemplary embodiment of the present invention. As shown in FIG. 1, an antenna device 10 according to the first exemplary embodiment of the present invention includes a conductor plate 101 touching a ground plate and a dielectric substrate 110 placed on the conductor plate 101 in a stacked manner in a thickness wise direction. However, it may be configured like a multilayer substrate by further increasing the number of layers. As shown in FIG. 2, the antenna device 10 has at least two antenna elements 102 and 103, and each of the antenna elements 102 and 103 is arranged near an end of the conductor plate 101, and electricity is supplied by giving an electric potential difference between the conductor plate 101 and the antenna elements through feeding points 102a and 103a.

The antenna device 10 further includes a first slotline 104 and a second slotline 105, and a width g2 of the second slotline is wider than a width g1 of the first slotline. One end of the first slotline 104 is an opening edge in an edge of the conductor plate 101, the edge belonging to an area between the antenna element 102 and 103, and the other end of the first slotline 104 connects with an end of the second slotline 105, and the other end of the second slotline 105 is short-circuited inside the conductor plate 101.

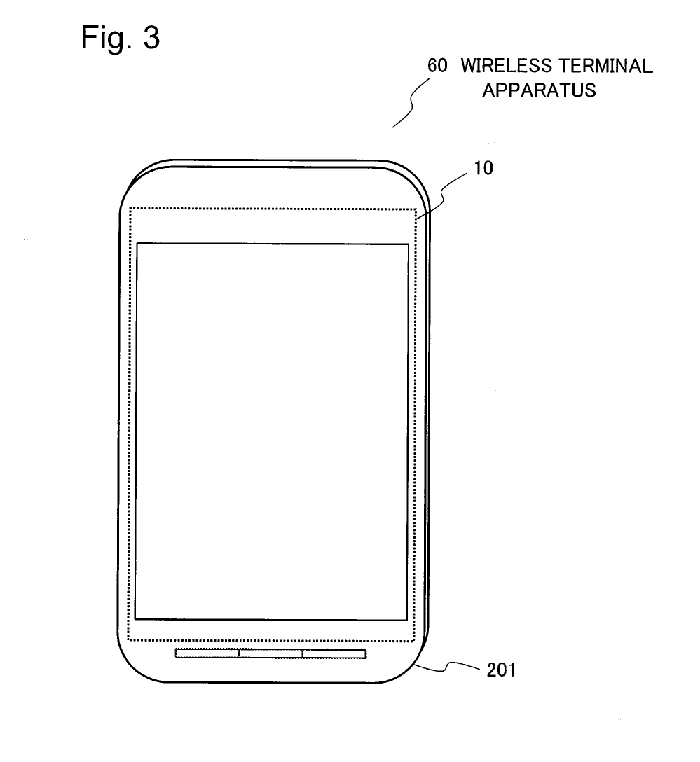

The antenna device 10 can be built-in in wireless terminal apparatus such as a personal computer and a cellular phone. FIG. 3 is a perspective view showing a structure of wireless terminal apparatus 60 equipped with the antenna device 10. As shown in FIG. 3, the wireless terminal apparatus 60 possesses a chassis 201 on which various components such as a button and a display are mounted, and the antenna device 10 is housed in the chassis 201 and various electronic circuitries are mounted on it additionally.

Hereinafter, an action and an effect of the exemplary embodiment of the present invention will be described.

When a slotline having an open end in an end of a conductor plate is formed in the neighborhood of the conductor plate end corresponding to an area between a plurality of antenna elements arranged in the conductor plate end, inter-antenna element interference is reduced. A slotline described in patent document 1 reduces interference between antenna elements by making the line length of a slotline be approximately a length of λ/4, where λ being the wavelength of an electromagnetic wave corresponding to the resonance frequency of the antenna elements, and by making one end of the slotline at a conductor plate end be an open end by short-circuiting the other end inside the conductor plate.

On the other hand, in the exemplary embodiment of the present invention, the first slotline 104 and the second slotline 105 have a stepped impedance structure, and thus input impedance Zₛₜₑₚ of the first slotline 104 and the second slotline 105 seen from the open end in the end of the conductor plate 101 is expressed by the following formula.

$$\begin{matrix}{Z}_{step} = {Z}_{slot 1} \frac{j {Z}_{slot 2} tan β {l}_{2} + j {Z}_{slot 1} tan β {l}_{1}}{{Z}_{slot 1} - {Z}_{slot 2} tan β {l}_{2} tan β {l}_{1}} & Formula ( 1 ) \\ β = \frac{2 π}{λ} & Formula ( 2 )\end{matrix}$$

Here, Zₛₗₒₜ₁ and Zₛₗₒₜ₂ are the characteristic impedance of the first slotline 104 and the second slotline 105, respectively, and l₁ and l₂ are length l₁ of the first slotline and length l₂ of the second slotline, respectively. Also, β is the propagation coefficient of a radio wave which propagates a slotline, and is expressed in Formula (2).

Because the opening of the first slotline 104 has only to be an open end at an end portion of the conductor plate 101 to suppress interference between the antenna elements 102 and 103, Zₛₜₑₚ should just meet the following formula.

Zₛₜₑₚ→∞ Formula (3)

Therefore, from Formula (1) and Formula (3), the following only has to hold.

$$\frac{{Z}_{slot 1}}{{Z}_{slot 2}} = tan β {l}_{1} tan β {l}_{2} \qquad Formula ( 4 )$$

In this exemplary embodiment, a formula Zₛₗₒₜ₁<Zₛₗₒₜ₂ holds because the width g₂ of the second slotline is wider than the width g₁ of the first slotline. Therefore, the left side of Formula (4) takes a numerical value smaller than 1. As a result, there will exist combinations by which the total line length l₁+l₂ becomes smaller than λ/4 among combinations of l₁ and l₂ which satisfy Formula (4), and it becomes possible to reduce the line length of the slotlines.

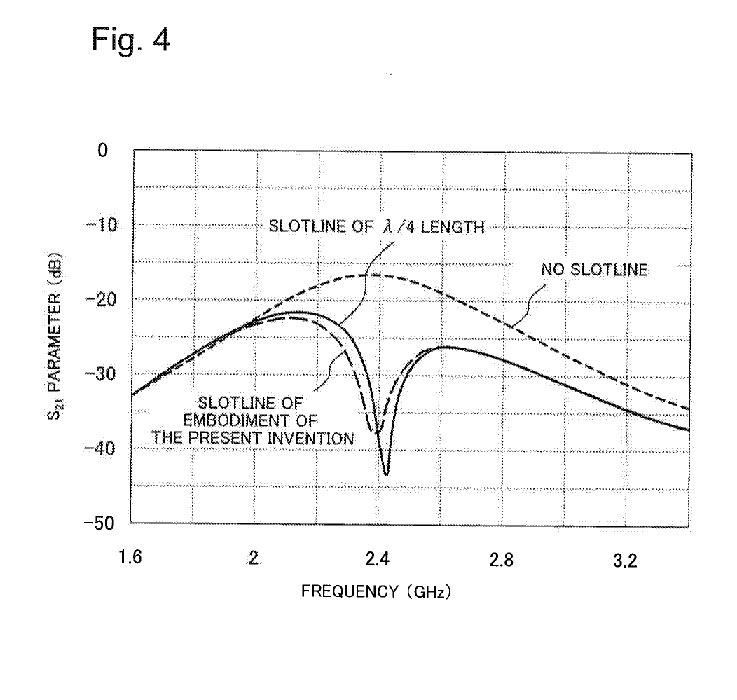

In FIG. 4, there is shown a result of electromagnetic field simulation having been performed to S₂₁ parameter between ports which supply electricity to two antenna elements in a substrate end about respective cases of: when there is no slotline; when there is a slotline of a length of λ/4 of wavelength λ of the resonance frequency of the antenna elements; and when there is a slotline of the exemplary embodiment of the present invention.

Each parameter at the time of the electromagnetic field simulation is as follows. That is, the conductor plate 101 is copper, the dielectric constant of the dielectric substrate 110 is 2.2, lengthwise length L of the conductor plate and the dielectric substrate is 204 mm, lateral length W of the conductor plate and the dielectric substrate is 200 mm, thickness d1 of the conductor plate is 30 μm and the thickness d2 of the dielectric substrate is 1 mm. The antenna elements 102 and 103 use antenna elements having a reverse-F shape as shown in FIG. 2, and their resonance frequency is 2.4 GHz. There is a distance of 65 mm between the feeding points of the respective antenna elements, and each of a slotline of a λ/4 length and a slotline of this exemplary embodiment is arranged almost in the center between the antenna elements in a similar fashion.

Regarding a width of a slotline, the slotline of λ/4 length has a width of 0.5 mm, and the width g₂ and the width g₁ of the first slotline and the second slotline of this exemplary embodiment are 0.5 mm and 5 mm, respectively. About a length of a slotline, the slotline of λ/4 length has a length of 26.25 mm, and both of the length l₁ of the first slotline and the length l₂ of the second slotline of this exemplary embodiment are 7.35 mm.

As shown in FIG. 4, S₂₁ parameters in the slotline of λ/4 length and the slotline of this exemplary embodiment are almost equal in the resonance frequency 2.4 GHz of the antenna elements. Therefore, it is confirmed that, in a slotline of the exemplary embodiment of the present invention, a total line length of the slotline required to suppress coupling between antenna elements can be made short compared with a slotline of λ/4 length.

As above, in this exemplary embodiment, inhibiting effect of interference between antenna elements can be obtained with the total line length l₁+l₂ of the first slotline 104 and the second slotline 105 that is a numerical value smaller than λ/4. Therefore, in this exemplary embodiment, there can be realized an antenna device which can obtain antenna characteristics to sufficiently reduce interference between antenna elements and which can achieve space-saving or miniaturization, and wireless terminal apparatus using this.

Meanwhile, when relational expressions of the arithmetic mean and the geometric mean that are generally known are applied to the left side of Formula (4), the following formula holds.

$$tan β {l}_{1} + tan β {l}_{2} ≧ 2 \sqrt{tan β {l}_{1}} \sqrt{tan β {l}_{2}} = 2 \sqrt{\frac{{Z}_{slot 1}}{{Z}_{slot 2}}} \qquad Formula ( 5 )$$

The equal sign holds between the first term and the second term of Formula (5) when the following formula holds.

l₁=l₂ Formula (6)

Therefore, the first term of Formula (5) at that time becomes a minimum value, and, at the same time, total line length l₁+l₂ also becomes a minimum value. Accordingly, a structure that satisfies Formula (4) and Formula (6) is most desirable. In this regard, however, in this exemplary embodiment, Formula (4) should be met approximately, and a structure is not limited to a structure that satisfies Formula (6).

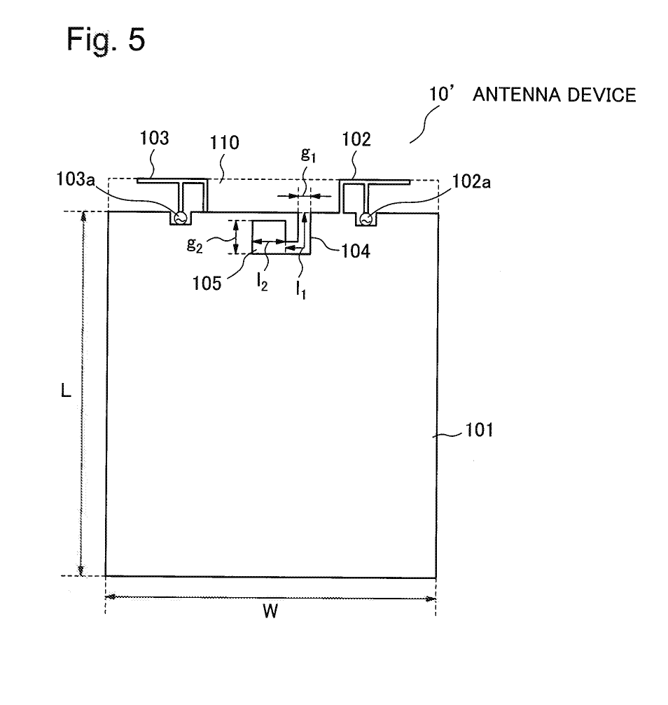

Furthermore, as shown in FIG. 5, a structure that makes the length of the exclusive-use space of a slotline in the conductor plate 101 in the inward direction shorter is also possible by bending the first slotline 104 and the second slotline 105 on the way at least once. FIG. 4 is a top view showing the antenna device 10′ of a modification of an antenna device of the first exemplary embodiment of the present invention. Also in this case, a suppression effect of interference between the antenna elements is realized when the length l₁ and l₂ that can be regarded as the line lengths of the first slotline 104 and the second slotline 105 satisfy Formula (4) approximately.

As above, an antenna device which can achieve miniaturization and space-saving while keeping a given characteristics as an antenna element and wireless terminal apparatus using this can be provided by the first exemplary embodiment of the present invention because interference between the antenna element can be reduced in a state that the total line length of the first slotline and the second slotline is shorter than a case when a slotline of a line length of a length of ¼ of the wavelength corresponding to the resonance frequency of an antenna element is formed.

### Second Exemplary Embodiment

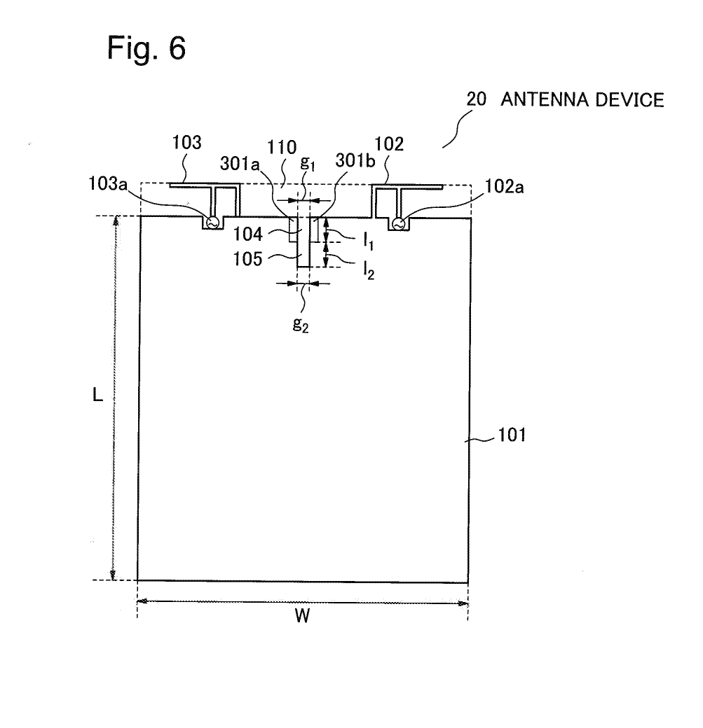

FIG. 6 is a top view showing a structure of an antenna device 20 of the second exemplary embodiment of the present invention. Different points of the antenna device 20 from the antenna device 10 of the first exemplary embodiment are: a point that the width g₁ of a first slotline and the width g₂ of a second slotline may be equal; and a point that a conductor part 301a and a conductor parts 301b, at least part of which oppose each other, are arranged further in the neighborhoods of the opposing conductor plate ends which form the slotline 104, and thus the other components are similar.

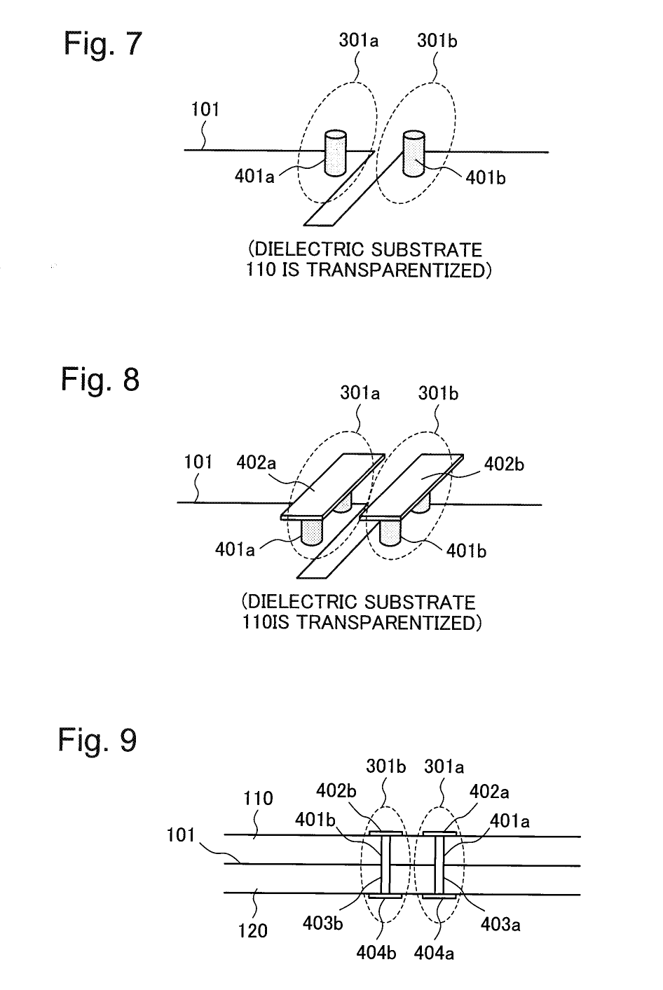

An enlarged perspective view of the conductor parts 301a and 301b is shown in FIG. 7. FIG. 7 is a perspective view of the conductor parts 301a and 301b seen from the side of the dielectric substrate 110, and the dielectric substrate 110 is transparentized for simplification. The conductor parts 301a and 301b include at least one piece of conductor via 401a and at least one piece of conductor via 401b, respectively, arranged in the dielectric substrate 110, and they are connected with the conductor plate 101 and are opposing each other.

Hereinafter, an effect of the conductor parts 301a and 301b that are the features of the second exemplary embodiment will be described. Because an area of opposing conductor parts of a slotline is increased only in the first slotline 104 due to the conductor parts 301a and 301b, characteristic impedance Zₛₗₒₜ₁ of the first slotline 104 becomes smaller than characteristic impedance Zₛₗₒₜ₂ of the second slotline 105. Therefore, the same effect as the first exemplary embodiment can be obtained because the first slotline 104 and the second slotline 105 form a stepped impedance structure and the left side of Formula (4) becomes smaller than 1.

Also similar to the first exemplary embodiment are: a point that total line length l₁+l₂ of slotlines will be a minimum value by satisfying Formula (6); and a point that a structure similar to FIG. 5, which makes a length that all slotlines exclusively possess in the inward direction in the conductor plate 101 short by bending the first slotline 104 and the second slotline 105 on the way, is possible.

Furthermore, as shown in FIG. 8, by increasing the number of pieces of the conductor vias 401a and 401b or by making it a multilayer substrate, a structure to form conductor plates 402a and 402b that are connected to the conductor vias 401a and 401b and are made to oppose each other into ends of the conductor via 401a and 401b opposite to ends connected to the conductor plate 101 is possible.

As shown in FIG. 9, also possible is a structure that makes characteristic impedance Zₛₗₒₜ₁ of the first slotline 104 further smaller by making areas of opposing conductors between the conductor parts 301a and 301b large by, in addition to the structure shown in FIG. 7: providing conductor vias 403a and 403b into a dielectric substrate 120 stacked on a side of the conductor plate 101 opposite to the side of the dielectric substrate 110 in a thickness wise direction, the conductor vias 403a and 403b connecting with the conductor plate 101 and being opposite to each other; and further connecting conductor plates 404a and 404b to ends opposite to ends of conductor vias 403a and 403b connected to the conductor plate 101, respectively. The numerical value of the left side of Formula (4) can be made smaller by making Zₛₗₒₜ₁ smaller, and total line length l₁+l₂ can be made shorter by this.

Thus, according to the second exemplary embodiment of the present invention, an antenna device which can achieve space-saving or miniaturization while keeping given characteristics as an antenna element and wireless terminal apparatus using this can be provided, because interference between antenna elements can be reduced in a state that the total line length of the first slotline and the second slotline is shorter than a case where a slotline of a line length of ¼ length of the wavelength corresponding to the resonance frequency of the antenna elements is formed.

### Third Exemplary Embodiment

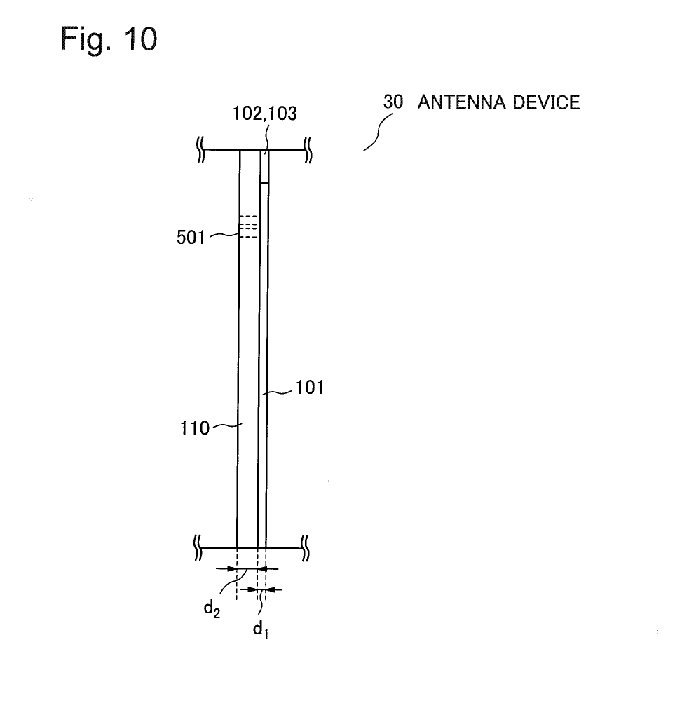

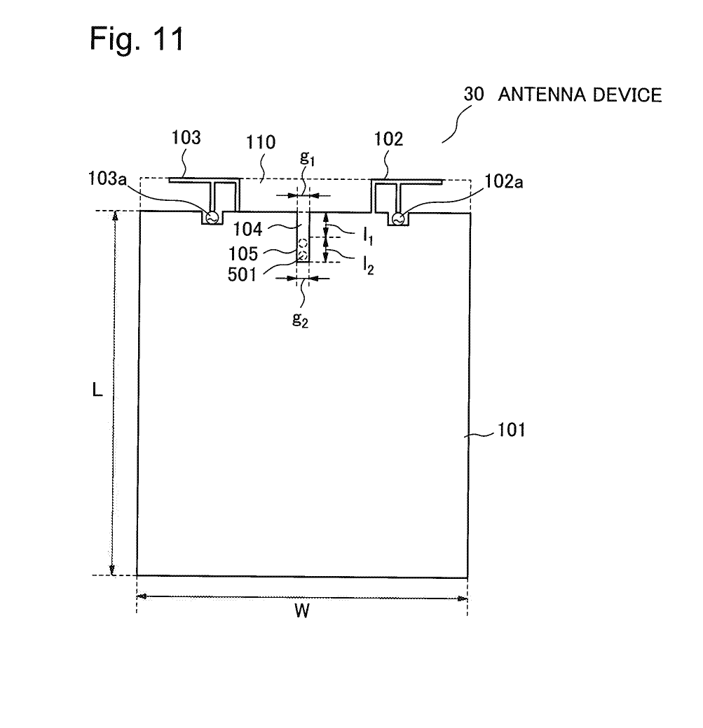

FIG. 10 is a side view showing a structure of an antenna device 30 of the third exemplary embodiment of the present invention. FIG. 11 is a top view showing a structure of the antenna device 30 of the third exemplary embodiment of the present invention.

The antenna device 30 is different from the antenna device 10 of the first exemplary embodiment: in a point that the width g₁ of the first slotline and the width g₂ of the second slotline may be equal; and in a point that at least one or more pieces of through-hole 501 are further formed in the dielectric substrate 110 that overlaps with the gap part of the second slotline 105, and the other components are similar.

Hereinafter, an effect of the through-hole 501 which is the feature of this exemplary embodiment will be described. By the through-hole 501, an effective dielectric constant in the space between the opposing conductor parts of the second slotline 105 declines, and as a result, characteristic impedance Zₛₗₒₜ₂ of the second slotline 105 becomes larger than characteristic impedance Zₛₗₒₜ₁ of the first slotline 104. Therefore, the same effect as the first exemplary embodiment can be obtained because the first slotline 104 and the second slotline 105 becomes a stepped impedance structure, and the left side of Formula (4) becomes smaller than 1.

Also similar to the first exemplary embodiment are: the point that the total line length l₁+l₂ of slotlines will be a minimum value by satisfying Formula (6); and the point that a structure similar to FIG. 5 that makes a length that all slotlines exclusively possess in the inward direction in the conductor plate 101 short by bending the first slotline 104 and the second slotline 105 on the way is possible.

Thus, according to the third exemplary embodiment of the present invention, an antenna device which can achieve space-saving or miniaturization while keeping given characteristics as an antenna element and wireless terminal apparatus using this can be provided, because interference between antenna elements can be reduced in a state that the total line length of the first slotline and the second slotline is shorter than a case where a slotline of a line length of ¼ length of the wavelength corresponding to the resonance frequency of the antenna elements is formed.

### Fourth Exemplary Embodiment

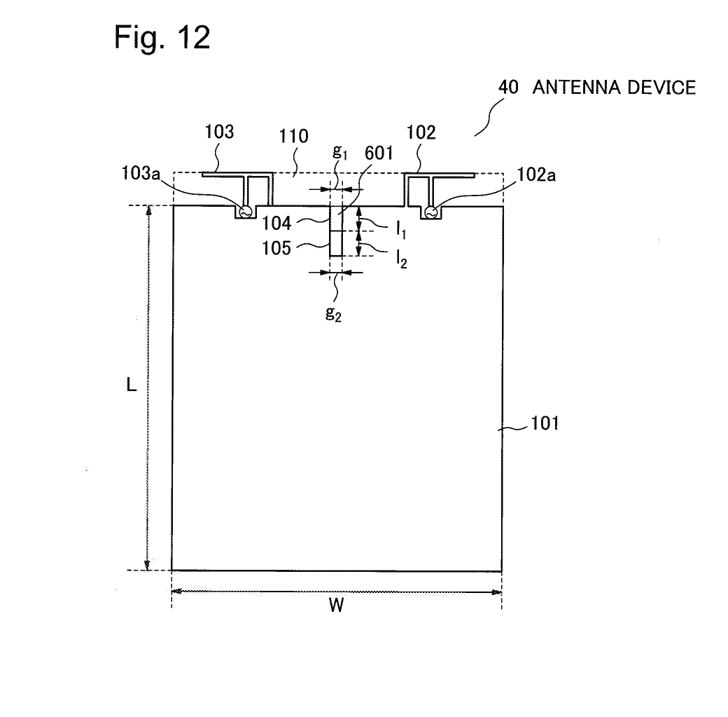

FIG. 12 is a top view showing a structure of an antenna device of the fourth exemplary embodiment of the present invention.

An antenna device 40 is different from the antenna device 10 of the first exemplary embodiment: in a point that the width g₁ of the first slotline and the width g₂ of the second slotline may be equal; and in a point that a dielectric part 601 having a dielectric constant larger than the dielectric constant of the dielectric substrate 110 is filled into at least part of a region among the gap part of the slotline 104 and its neighborhood spaces except for the conductor plate 101, and thus the other components are similar.

Hereinafter, an effect of the dielectric part 601 will be described. By the dielectric part 601, a capacitance between the opposing edges of the conductor plate 101 that form the first slotline 104 is increased. Therefore, characteristic impedance Zₛₗₒₜ₁ of the first slotline 104 becomes smaller than characteristic impedance Zₛₗₒₜ₂ of the second slotline 105. Accordingly, the same effect as the first exemplary embodiment can be obtained because the first slotline 104 and the second slotline 105 become a stepped impedance structure, and the left side of Formula (4) becomes smaller than 1.

Also similar to the first exemplary embodiment are: a point that the total line length l₁+l₂ of slotlines will be a minimum value by satisfying Formula (6); and a point that a structure similar to FIG. 5 that makes a length that all slotlines exclusively possess in the inward direction in the conductor plate 101 short by bending the first slotline 104 and the second slotline 105 on the way is possible.

Thus, according to the fourth exemplary embodiment of the present invention, an antenna device which can achieve space-saving or miniaturization while keeping given characteristics as an antenna element and wireless terminal apparatus using this can be provided, because interference between antenna elements can be reduced in a state that the total line length of the first slotline and the second slotline is shorter than a case where a slotline of a line length of ¼ length of the wavelength corresponding to the resonance frequency of the antenna elements is formed.

### Fifth Exemplary Embodiment

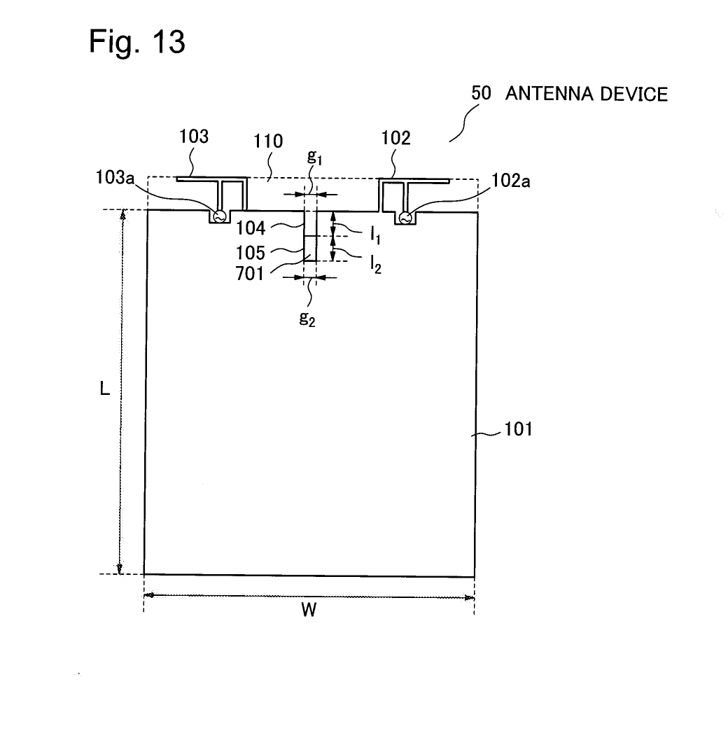

FIG. 13 is a top view showing a structure of an antenna device of the fifth exemplary embodiment of the present invention. An antenna device 50 is different from the antenna device 10 of the first exemplary embodiment: in a point that the width g₁ of the first slotline and the width g₂ of the second slotline may be equal; and in a point that a magnetic substance part 701 having a magnetic permeability larger than the magnetic permeability of the dielectric substrate 110 is filled into at least part of a region among the gap part of the slotline 105 and its neighborhood spaces except for the conductor plate 101, and thus the other components are similar.

Hereinafter, an effect of the magnetic substance part 701 will be described. By the magnetic substance part 701, a series inductance of the second slotline 105 as a transmission line increase. Therefore, characteristic impedance Zₛₗₒₜ₂ of the second slotline 105 becomes larger than characteristic impedance Zₛₗₒₜ₁ of the first slotline 104. Accordingly, the same effect as the first exemplary embodiment can be obtained because the first slotline 104 and the second slotline 105 become a stepped impedance structure, and the left side of Formula (4) becomes smaller than 1.

Also similar to the first exemplary embodiment are: a point that the total line length l₁+l₂ of slotlines will be a minimum value by satisfying Formula (6); and a point that a structure similar to FIG. 5 that makes a length that all slotlines exclusively possess in the conductor plate 101 in the inward direction short by bending the first slotline 104 and the second slotline 105 on the way is possible.

Thus, according to the fifth exemplary embodiment of the present invention, an antenna device which can achieve space-saving or miniaturization while keeping given characteristics as an antenna element and wireless terminal apparatus using this can be provided, because interference between antenna elements can be reduced in a state that the total line length of the first slotline and the second slotline is shorter than a case where a slotline of a line length of ¼ length of the wavelength corresponding to the resonance frequency of the antenna elements is formed.

Meanwhile, the first, second, third, fourth and fifth exemplary embodiments mentioned above can be combined within a range where their contents do not disagree with each other. Various modifications of the present invention are possible within the scope of the invention described in the claims without limiting to the above-mentioned exemplary embodiments, and it goes without saying that those are also included within the scope of the present invention.

This application claims priority based on Japanese application Japanese Patent Application No. 2012-064789 filed on Mar. 22, 2012, the disclosure of which is incorporated herein in its entirety.

### INDUSTRIAL APPLICABILITY

The present invention relates to an antenna device having a plurality of antenna elements, and, more particularly, to an antenna device which reduces interference between antenna elements and achieves space-saving and miniaturization.

### REFERENCE SIGNS LIST

10, 10′, 20, 30, 40 and 50 Antenna device
60 Wireless terminal apparatus
101 Conductor plate
102 and 103 Antenna element
102a and 103a Feeding point
104 First slotline
105 Second slotline
110 and 120 Dielectric substrate
201 Chassis
301a and 301b Conductor part
401a, 401b, 403a and 403b Conductor via (those are included in 301a and 301b)
402a, 402b, 404a and 404b Conductor plate (those are included in 301a and 301b)
501 Through-hole
601 Dielectric part
701 Magnetic substance part
d1 Thickness of a conductor plate
d2 Thickness of a dielectric substrate
L Lengthwise length of a conductor plate and a dielectric substrate
W Lateral length of a conductor plate and a dielectric substrate
l₁ Length of a first slotline
l₂ Length of a second slotline
g₁ Width of a first slotline
g₂ Width of a second slotline

1. An antenna device, comprising:
a conductor plate; at least two antenna elements arranged near an end of said conductor plate; a first slotline formed into said conductor plate, said first slotline having a characteristic impedance of an optional numerical value Z1; a second slotline formed into said conductor plate, said second slotline having a characteristic impedance of an optional numerical value Z2 larger than Z1; one end of said first slotline being an open end in an area between said antenna elements within said conductor plate end; an other end of said first slotline connecting with one end of said second slotline; and an other end of said second slotline being short-circuited inside said conductor plate.

2. The antenna device according to claim 1, wherein
a width of said second slotline is wider than a width of said first slotline.

3. The antenna device according to claim 1, further comprising:
conductor parts A1 and B1 in a neighborhood of each of areas A and B near opposing ends of said conductor plate forming said first slotline, at least part of said conductor parts A1 and B1 opposing each other; said conductor parts A1 and B1 being connected to said areas A and B of said conductor plate end, respectively; and said conductor parts A1 and B1 not being connected with each other.

4. The antenna device according to claim 1, wherein
a substance having a dielectric constant larger than an effective dielectric constant of a gap part of said first slotline is filled into at least part of said gap part of said first slotline further.

5. The antenna device according to claim 1, wherein
a substance having a magnetic permeability larger than an effective magnetic permeability of a gap part of said second slotline is filled into at least part of said gap part of said second slotline and in near spaces except for said conductor plate further.

6. The antenna device according to claim 1, wherein
said conductor plate is installed on a dielectric substrate.

7. The antenna device according to claim 1, wherein
at least one through-hole is provided in an area of said dielectric substrate overlapping said gap part of said second slotline.

8. The antenna device according to claim 1, wherein
at least part of said first and said second slotline is of a bent shape.

9. The antenna device according to claim 1, wherein
said first slotline and said second slotline have lengths capable of being assumed to be approximately identical.

10. A wireless terminal apparatus comprising an antenna device according to claim 1.
